(19) United States
(12) Patent Application Publication
(10) Pub. No.: US 2010/0083905 A1
(43) Pub. Date: Apr. 8, 2010

(54) STRIP WEATHER SHIELDED FEEDER

(75) Inventors: Edward S. Robbins, III, Muscle Shoals, AL (US); Josef A. Boukal, Madison, AL (US); Bryan F. Magee, Killen, AL (US); John A. Morgan, Cypress Inn, TN (US)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(73) Assignee: E.S.Robbins

(21) Appl. No.: 12/555,114

(22) Filed: Sep. 8, 2009

Related U.S. Application Data
(60) Provisional application No. 61/103,608, filed on Oct. 8, 2008.

(51) Int. Cl. A01K 5/01

(52) U.S. Cl. 119/52.1; 119/61.3

(57) ABSTRACT

An animal feeder includes a base, a feeding trough supported by the base, the feeding trough having an outer rim. A feed hopper is situated over the feeding trough to deliver feed to the feeding trough. A roof extends laterally at least over the feeding trough outer rim. A curtain formed from a plurality of adjacent vertically elongated members having upper ends connected to the roof and lower ends extending downward laterally outside the feeding trough outer rim so that the vertically elongated members of the curtain inhibit rain and other weather related elements from contacting the feeding trough while being displaceable by an animal seeking access to the feeding trough

### CROSS-REFERENCE TO RELATED APPLICATIONS

The present invention is related to and claims all available benefit of provisional application Ser. No. 61/103,608 filed Oct. 8, 2008.

### BACKGROUND OF THE INVENTION

The present invention relates to animal feeders, and particularly to feeders for domestic animals including shielding for inhibiting the weather-related wetting of grain or other feed held within the feeder.

Various forms of feeding devices are known, particularly for domestic animals such as horses, sheep, goats, hogs and cattle, which can be used in an open field without replenishment of the feed contained therein over relatively long periods of time. In order to provide satisfactory feeding over relatively long periods of time, it is necessary for the device to include feed storage means, for storing and protecting relatively large quantities of feed from the elements, in addition to providing controlled access to the feed. The device can be fixed in position or movable on a base including a sled or wheels.

The feed storage means often takes the form of a hopper that can be defined by a pair of side walls and a pair of end walls. At least one of the pair of side walls and end walls is typically downwardly and inwardly sloping so as to define a narrow opening at the bottom of the hopper. The hopper can also take the form of a cylindrical structure having an inverted frustoconical lower wall again defining a narrow opening at the bottom of the hopper. The hopper can include a roof designed to protect the contents of the hopper from rain and other weather related elements. The opening at the bottom of the hopper can be positioned a spaced distance above a trough. The trough generally has a lateral extent that is greater than the opening at the bottom of the hopper so that feed within the hopper will spill laterally outwardly a sufficient distance to permit an animal to have access to the feed. The lateral extent of the trough is desirably confined within the lateral extent of the roof so that the trough and any contents are also at least partly protected from rain and other weather related elements. Examples of such structures are to be found in U S. Design Patent 209,753; U.S. Utility Patent Nos. 4,580,528 and 6,637,369; and U.S. Patent Publication No. 2007/0163505.

While such feed storage means are often designed, as indicated above, to provide some protection from rain and other weather related elements, wind-blown rain and other severe weather conditions can detrimentally impact the feed present in the trough so that the feed is no longer palatable to the animals. Despite the various features and benefits of the structures of the forgoing disclosures, there remains a need for improved means for inhibiting the weather-related destruction of the feed while at the same time providing acceptable access to the feed for the animals. There also remains a need for an inexpensive retrofitting of existing feed storage means to enhance the weather resistance of the structures while still providing acceptable access to the feed for the animals.

### SUMMARY OF THE INVENTION

These several needs may be satisfied by an animal feeder that includes a base and a feeding trough supported by the base. The feeding trough can have an outer rim defining a perimeter of a feed supporting area. A feed hopper can be situated over the feeding trough, the feed hopper including a lower opening to deliver feed to the feeding trough. A roof can be situated over the feed hopper, the roof having an outer edge extending laterally at least over the feeding trough outer rim. A curtain can be formed from a plurality of adjacent vertically elongated members with each member having an upper end connected to the roof adjacent the roof outer edge. Each of the curtain elongated members can have a lower end extending downward laterally outside of the feeding trough outer rim. The vertically elongated members of the curtain can be of sufficient weight to inhibit the entry of rain and other weather related elements onto the feeding trough, but can be displaced by an animal seeking access to the feeding trough.

The animal feeder base can be supported on wheels to provide mobility to the animal feeder. The feeding trough outer rim can be linear so as to extend continuously between a first end and a second end of the feed hopper. Alternatively, the feeding trough outer rim can be circular and uniformly situated at a fixed distance from a vertical axis of the feed hopper. The vertically elongated members of the curtain can be substantially transparent to provide visual reinforcement to the animals of the presence of feed within the trough. The lower ends of the vertically elongated members of the curtain can be spaced above the ground but below the feed trough outer rim. Adjacent members of the vertically curtain can be overlapping to enhance the resistance of the curtain to rain and other weather related elements.

Other features of the present invention and the corresponding advantages of those features will be come apparent from the following discussion of the preferred embodiments of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a perspective view of the front and one side of a mobile feeder unit including a support structure for a shielding curtain.

FIG. 2 is a perspective view of the rear and side of the mobile feeder unit shown in FIG. 1 with a shielding curtain.

FIG. 3 is a side elevation view of the mobile feeder unit shown in FIGS. 1 and 2.

FIG. 4 is a perspective view of the front and one side of a portable feeder unit including a support structure for a shielding curtain.

FIG. 5 is a perspective view of the rear and side of the portable feeder unit shown in FIG. 4 with a shielding curtain.

FIG. 6 is a perspective view of another feeder unit showing a support structure for a shielding curtain on one half and the shielding curtain on the other half of the unit.

FIG. 7 is a detail cross-sectional view of a shielding curtain and support taken from FIG. 6.

### DESCRIPTION OF PREFERRED EMBODIMENTS

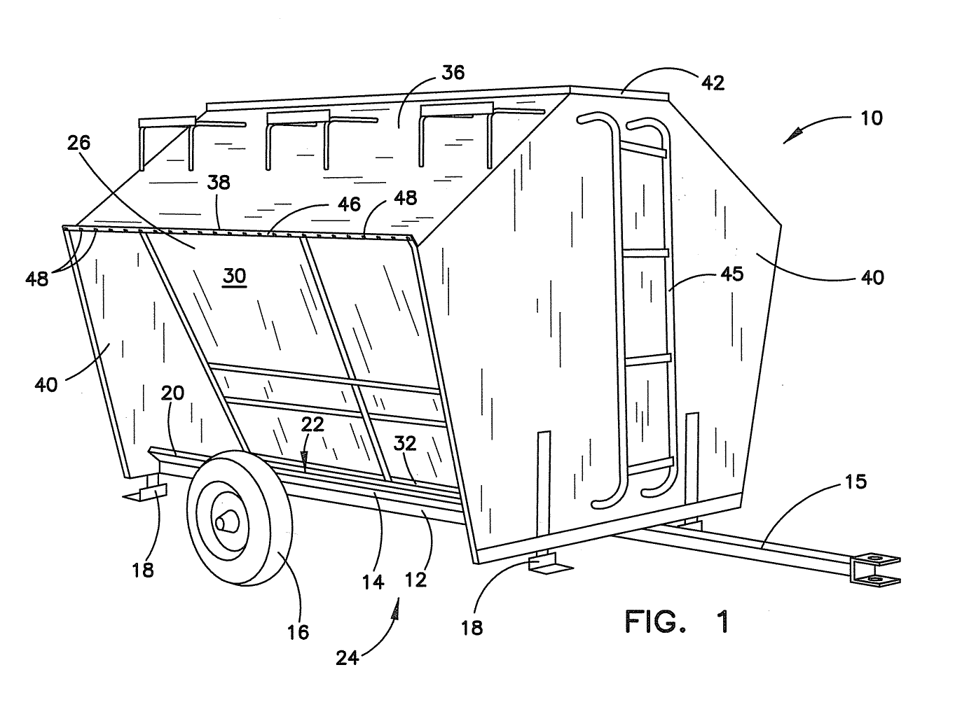

A mobile animal feeder 10 is shown in FIGS. 1-3 that includes a base 12 and a feeding trough 14 supported by the base. The animal feeder base 12 can be supported on wheels 16 to provide mobility to the animal feeder 10. A tongue 15 can extend outwardly from the base 12 to permit the feeder 10 to be towed from one location to another location. The feeder 10 can additionally include a plurality of feet 18 that can be vertically movable relative to the base 12 to provide for stationary support for the feeder 10 with respect to the underlying ground.

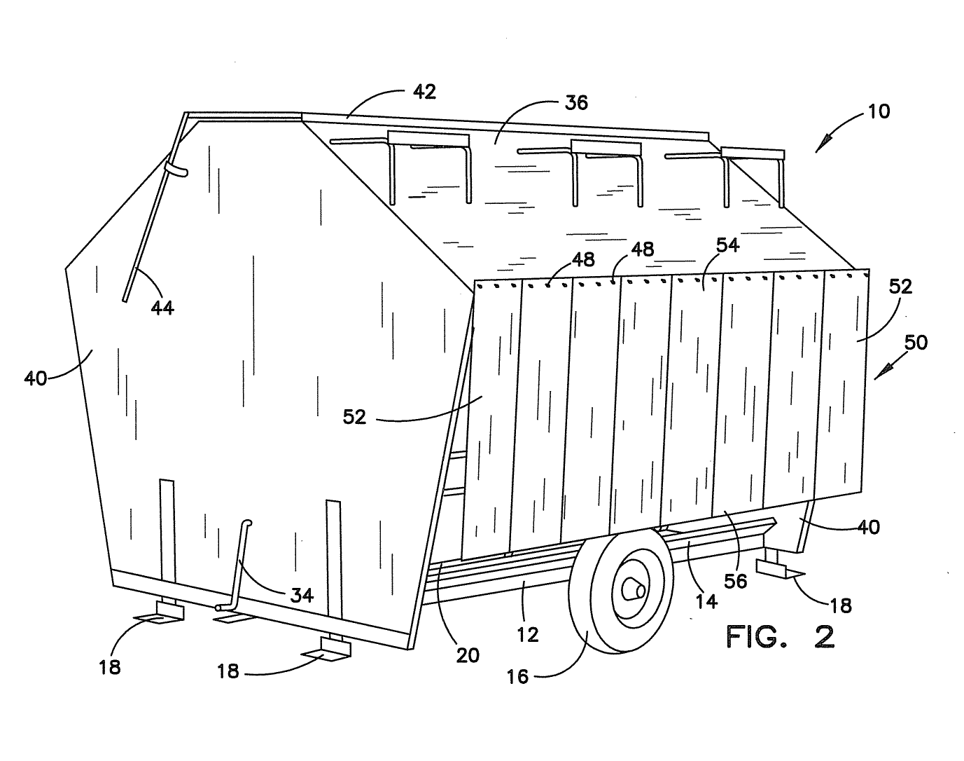

The feeding trough 14 can have a linear outer rim 20 defining a lateral perimeter 22 of a feed supporting area 24. A feed hopper 26 can be situated over the feeding trough 14, with the feed hopper including a lower opening that can gravitationally deliver feed from the hopper 26 to the feeding trough 14. The hopper 26 can have sloping side walls 30 having lower edges 32 that define the lower opening of the hopper. The feed hopper opening can be controlled by a handle 34 shown in FIG. 2.

A roof 36 can be situated over the feed hopper 26. The roof 36 can have an outer edge 38 extending laterally at least over the feeding trough outer rim 20. The roof 36 can be supported by end panels 40 that are fixed to the base 12 and to the side walls 30. The roof 36 can include a top panel 42 that can be moved between a closed position as shown and an open position allowing feed to be loaded into the hopper 26. The position of the roof 36 can be controlled by a second handle 44 as shown in FIG. 2. A ladder 45, shown in FIG. 1, can be fixed to one if the end panels 40 to permit inspection of the hopper 26.

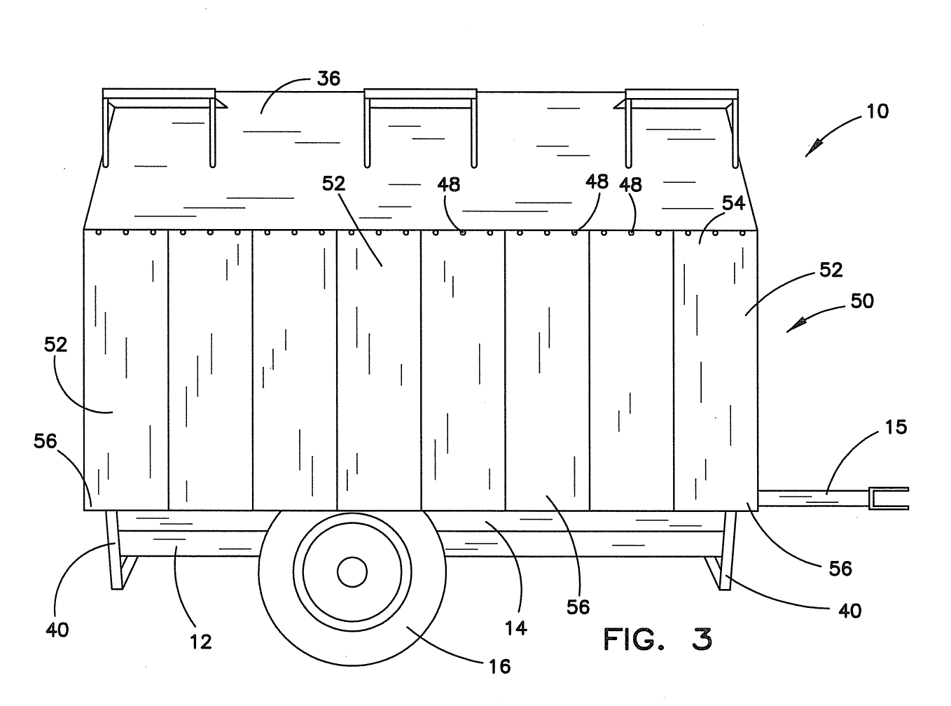

A curtain support 46, which can comprise a plurality of projections 48, can be arranged along the outer edge 38 of the roof 36. A curtain 50 can be formed from a plurality of adjacent vertically elongated members 52, as shown in FIGS. 2 and 3, with each member having an upper end 54 connected to the curtain support 46 situated adjacent the roof outer edge 38. Each of the curtain elongated members 52 can have a lower end 56 extending downward laterally outside of the feeding trough outer rim 20. The lower end 56 of the elongated members 52 can extend below the outer rim 20 of the feeding trough 14 as shown in FIG. 3. The vertically elongated members 52 of the curtain can be of sufficient weight to inhibit the entry of rain and other weather related elements onto the feeding trough 14, but can be displaced by an animal seeking access to the feeding trough 14.

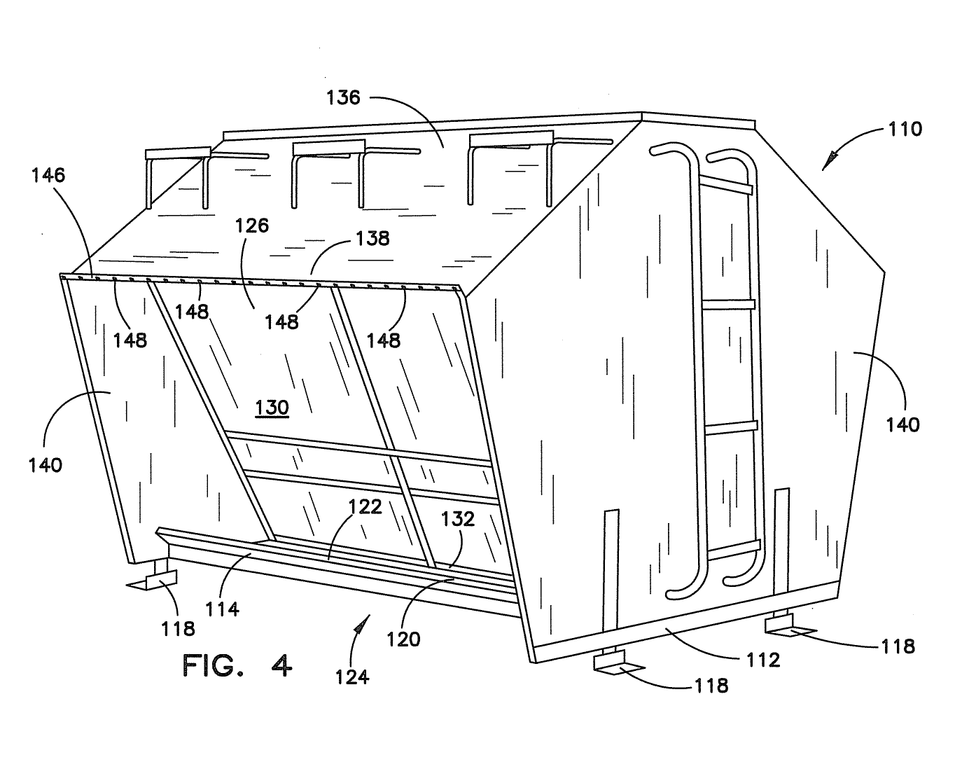

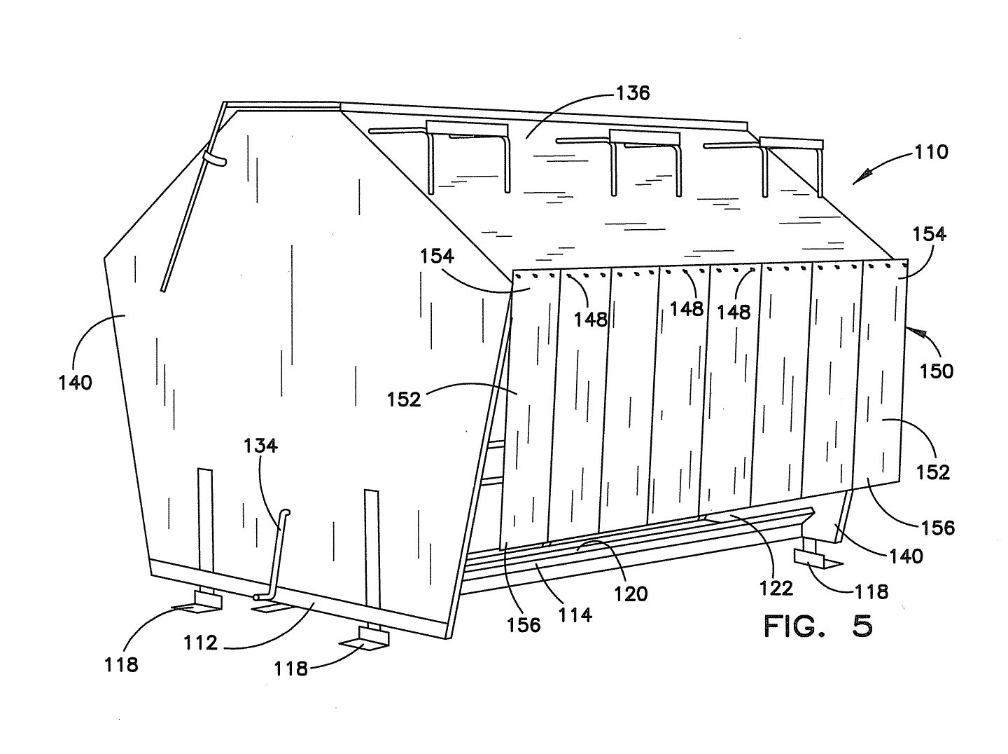

A portable animal feeder 110 is shown in FIGS. 4 and 5 that can be transported from location to location on a truck or trailer, not shown, and off-loaded at a desired location. The portable animal feeder 110 includes a base 112 and a feeding trough 114 supported by the base. The feeder 110 can additionally include a plurality of feet 118 that can be vertically movable relative to the base 112 to provide for stationary support for the feeder 110 with respect to the underlying ground.

The feeding trough 114 can have a linear outer rim 120 defining a lateral perimeter 122 of a feed supporting area 124. A feed hopper 126 can be situated over the feeding trough 114, with the feed hopper including a lower opening that can gravitationally deliver feed from the hopper 126 to the feeding trough 114. The hopper 126 can have sloping side walls 130 having lower edges 132 that define the lower opening of the hopper. The feed hopper opening can be controlled by a handle 134 shown in FIG. 5. A roof 136 can be situated over the feed hopper 126. The roof 136 can have an outer edge 138 extending laterally at least over the feeding trough outer rim 120. The roof 136 can be supported by end panels 140 that can be fixed to the base 112 and to the side walls 130.

A curtain support 146, which can comprise a plurality of projections 148, can be arranged along the outer edge 138 of the roof 136. A curtain 150 can be formed from a plurality of adjacent vertically elongated members 152, as shown in FIG. 5, with each member having an upper end 154 connected to the curtain support 146 situated adjacent the roof outer edge 138. Each of the curtain elongated members 152 can have a lower end 156 extending downward laterally outside of the feeding trough outer rim 120. The lower end 156 of the elongated members 152 can extend below the outer rim 120 of the feeding trough 114 similar to the manner shown in FIG. 3, or can terminate above the outer rim 120 of the feeding trough 114 as shown in FIG. 5. The vertically elongated members 152 of the curtain can be of sufficient weight to inhibit the entry of rain and other weather related elements onto the feeding trough 114, but can be displaced by an animal seeking access to the feeding trough 114.

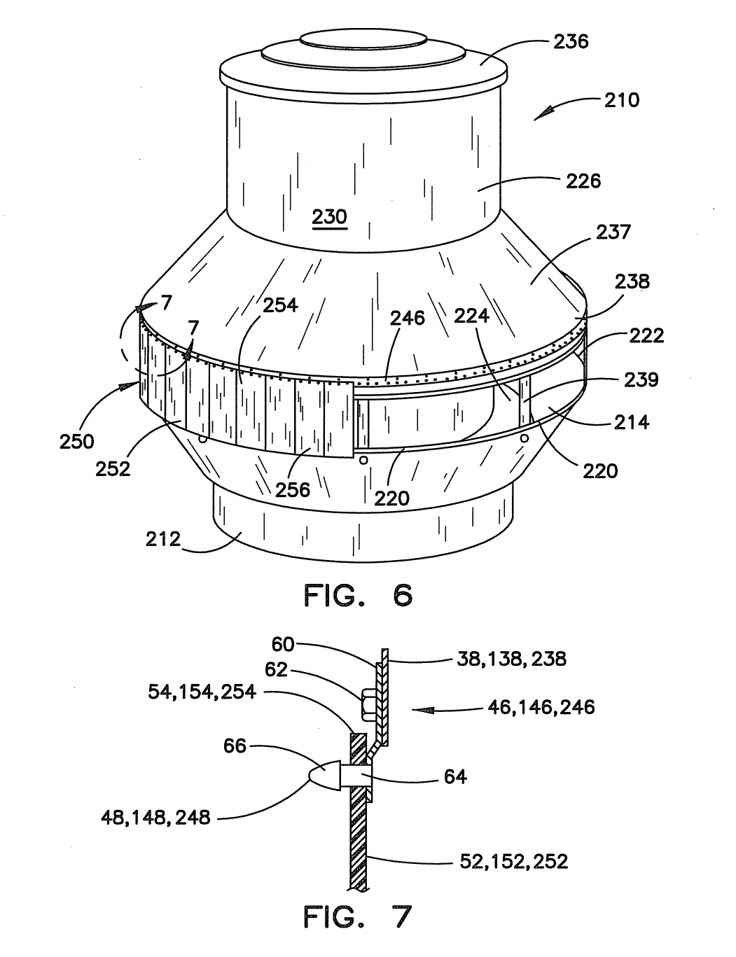

Another animal feeder 210 is shown in FIG. 6 that includes a base 212 and a feeding trough 214 supported by the base. The feeding trough 214 can have a curved outer rim 220 defining a closed perimeter 222 of a feed supporting area 224. A feed hopper 226 can be situated over the feeding trough 214, with the feed hopper including a lower opening that can gravitationally deliver feed from the hopper 226 to the feeding trough 214.

A roof 236 can be situated over the feed hopper 226. A further roof extension 237 can have an outer edge 238 extending outwardly at least over the feeding trough outer rim 220. The roof extension 237 can be supported by a side wall 230 of the feed hopper 226. The roof extension 237 can also be supported by support members 239 that are fixed to the feeding trough 214 or to the base 212.

A curtain support 246, which can comprise a plurality of projections 248, can be arranged along the outer edge 238 of the roof extension 237. A curtain 250 can be formed from a plurality of adjacent vertically elongated members 252, with each member having an upper end 254 connected to the curtain support 246 situated adjacent the roof extension outer edge 238. Each of the curtain elongated members 252 can have a lower end 256 extending downward laterally outside of the feeding trough outer rim 220. The lower end 256 of the elongated members 252 can extend below the outer rim 220 of the feeding trough 214 as shown in FIG. 6. The vertically elongated members 252 of the curtain 250 can be of sufficient weight to inhibit the entry of rain and other weather related elements onto the feeding trough 214, but can be displaced by an animal seeking access to the feeding trough 214.

One embodiment of the curtain support 46, 146, 246 is shown in FIG. 7 to include a bar member 60 that can be attached to an outer edge 38, 138, 238. The bar member 60 can be secured in place by fasteners 62 or other comparable fastening means including screws, bolts, welding and adhesive bonding. The plurality of projections 48, 148, 248 can be secured to the bar member to project outwardly. Alternatively, the plurality of projections 48, 148, 248 can be secured directly to the outer edge 38, 138, 238. The projections 48, 148, 248 can take the form of a base 64 having a first cross-section and a head portion 66 having a larger cross-section. The vertically elongated members 52, 152, 252 of the curtain 50, 150, 250 can include openings sized and spaced to facilitate easy attachment of the upper ends 54, 154, 254 onto the projections 48, 148, 248. The larger cross-sectioned head portions 66 ensure that the vertically elongated members 52, 152, 252 will be retained on the projections 48, 148, 248 despite wind and other weather conditions.

While these features have been disclosed in connection with the illustrated preferred embodiments, other embodiments of the invention will be apparent to those skilled in the art that come within the spirit of the invention as defined in the following claims.

What is claimed is:

1. An animal feeder comprising: a base for supporting the animal feeder on the ground, a feeding trough supported by the base, the feeding trough having an outer rim, a feed hopper situated over the feeding trough, the feed hopper including a lower opening to deliver feed to the feeding trough, a roof situated over the feed hopper, the roof extending laterally at least over the feeding trough outer rim, and a curtain formed from a plurality of adjacent vertically elongated members, each member having an upper end connected to the roof and a lower end extending downward laterally outside of the feeding trough outer rim, the vertically elongated members of the curtain inhibiting rain and other weather related elements from contacting the feeding trough while being displaceable by an animal seeking access to the feeding trough.

2. The animal feeder of claim 1, wherein the base includes wheels to provide mobility to the animal feeder.

3. The animal feeder of claim 1, wherein the feeding trough outer rim is linear and extends continuously between a first end and a second end of the feed hopper.

4. The animal feeder of claim 1, wherein the feeding trough outer rim is circular and is situated uniformly distanced from a vertical axis of the feed hopper.

5. The animal feeder of claim 1, wherein the roof further comprises an outer edge having a plurality of substantially equally spaced projections penetrating the upper ends of the vertically elongated members of the curtain.

6. The animal feeder of claim 1, wherein the vertically elongated members of the curtain are substantially transparent.

7. The animal feeder of claim 1, wherein the lower ends of the vertically elongated members of the curtain are spaced above the ground and below the feeding tough outer rim.

8. The animal feeder of claim 1, wherein adjacent members of the vertically elongated members of the curtain are overlapping.

9. An animal feeder comprising: a base for supporting the animal feeder on the ground, a feeding trough supported by the base, the feeding trough having an outer rim, a feed hopper situated over the feeding trough, the feed hopper including a lower opening to deliver feed to the feeding trough, a roof situated over the feed hopper, the roof having an outer edge extending laterally outward over the feeding trough outer rim, a plurality of substantially equally spaced projections fixed to the roof outer edge, and a curtain formed from a plurality of adjacent vertically elongated members, each vertically elongated member having an upper end including a plurality of openings connected to the equally spaced projections fixed to the outer edge of the roof, each vertically elongated member having a lower end extending downward laterally outside of the feeding trough outer rim, the vertically elongated members of the curtain inhibiting rain and other weather related elements from contacting the feeding trough while being displaceable by an animal seeking access to the feeding trough.

10. The animal feeder of claim 9, wherein the vertically elongated members of the curtain are substantially transparent.

11. The animal feeder of claim 9, wherein the lower ends of the vertically elongated members of the curtain are spaced above the ground and below the feeding trough outer rim.

12. The animal feeder of claim 9, wherein adjacent members of the vertically elongated members of the curtain are overlapping.

13. The animal feeder of any of claims 9, 10, 11 or 12, wherein the base includes wheels to provide mobility to the animal feeder.

14. The animal feeder of any of claims 9, 10, 11 or 12, wherein the feeding trough outer rim is linear and extends continuously between a first end and a second end of the feed hopper.

15. The animal feeder of any of claims 9, 10, 11 or 12, wherein the feeding trough outer rim is circular and is situated uniformly distanced from a vertical axis of the feed hopper.
